(19) United States
(12) Patent Application Publication
(10) Pub. No.: US 2014/0309319 A1
(43) Pub. Date: Oct. 16, 2014

(54) METHOD FOR SEPARATING AND REMOVING INERT COMPONENTS FROM CARPET WASTE MATERIAL

(71) Applicant: CARPET RECYCLING, LLC, PRINCETON, NJ (US)

(72) Inventor: ROLAND STEFANDL, PRINCETON, NJ (US)

(73) Assignee: CARPET RECYCLING, LLC, PRINCETON, NJ (US)

(21) Appl. No.: 13/860,987

(22) Filed: Apr. 11, 2013

(51) Int. Cl. C08J 11/04

(52) U.S. Cl. CPC C08J 11/04
USPC 521/41; 521/49.8

(57) ABSTRACT

The invention comprises a method for the separation and removal of inert components, from carpet waste materials, such as from fiber flooring, rugs, carpet components, carpet material and all other textiles that contain fiber materials, both natural and synthetic or from carpet waste composed of processed carcasses comprising at least one polymeric fiber with the method comprising the steps of (a) placing the carpet waste material into an acid solvent, (b) solubilizing at least one net component of the carpet waste material by chemical reaction with the acid solvent at low pH and (c) reacting the carpet waste material in the acid solvent at a temperature corresponding to room temperature or a low ambient reaction temperature below the dissolution temperature of any of the fiberous textiles in the carpet waste such that two unique phases are simultaneously formed from the reaction with one being a liquid phase consisting of as solublized compound dissolved in water and the other comprising a stream of polymeric textile fibers in solid phase.

### FIELD OF INVENTION

The invention comprises a method and/or process for the separation and removal of inert components in a liquid phase from carpet waste material and more particularly the economic separation and removal of the inert components from the carpet waste by conversion into a solubilized compound for removal in a liquid phase at a temperature corresponding to room temperature or a low ambient reaction temperature below the dissolution temperature of the textile fibers in the carpet waste such that the reaction forms a liquid phase consisting of the solubilized inert components of the carpet waste and a solid phase comprising fiberous textile materials, natural and/or synthetic.

### BACKGROUND

The largest amount of carpet waste, is the result of discarded post-consumer, post-industrial, post-commercial carpet. It is estimated that about 2.3 million tons of carpet and rugs were placed in the municipal solid waste stream in 2006, of which less than 5% was recovered for recycling. Carpet is a complex, multi-component system. The tufted carpet, the most common type, typically consists of two layers of backing (mostly polypropylene fabrics), joined by a calcium carbonate (CaCO3) filled styrene-butadiene latex rubber (SBR), and face fibers (majority being nylon 6 and nylon 6, 6 textured yarns) tufted into the primary backing. The SBR adhesive is a thermoset material, which cannot be re-melted or reshaped. Carpet waste containing SBR and CaCO3 (post consumer and post-industrial waste) has no suitable use and is, in general, disposed of as waste in landfills. Because about 70% of carpet produced is for replacing old carpet, it is important to understand the amount and types of carpet produced. Using the typical life of a carpet of 5-10 years, one can estimate the amount of carpet being disposed carpet waste currently and in the next few years. According to carpet industry statistics, the total fiber consumption in year 2006 was about 2.7 million tons: Nylon 57%, Olefin 36%, Polyester 7%, and Wool 0.4%. Among the nylon face fiber, about 50% is nylon 6 and 50% is nylon 6,6. In recent years, the use of polypropylene and polyester in carpet is increasing. Based on the aforementioned data, one expects the current rate of carpet disposal to be about 2 million tons per year; or about 70% of the shipment in 2006. The amount of the various materials used in carpet manufacturing in the U.S. in 2006. Nylon generally performs the best among all synthetic fibers as carpet face yarn, but it is also the most expensive. Typical price per kg for the plastic resins are: Nylon $3.50, Polyester $2.00, and Polypropylene $2.20. This price list provides a perspective on the economics of recycling as well. For example, if it takes the same processing effort to convert the fiber into resin, an operation on nylon would be most profitable. This also explains why most of the carpet recycling effort today is based on nylon recovery.

Many carpet manufacturers, fiber and chemical suppliers, recycling companies, and academic institutions are actively pursuing various methods to recycle fibrous textiles from carpet waste. The approaches include chemical processes to depolymerize nylon and other polymers, recovery of plastic resins from carpet fibers, direct extrusion of mixed carpet waste, composites as wood substitutes, fibers for concrete and soil reinforcement, waste-to-energy conversion, and carpet as feedstock for cement kilns.

Mechanical methods have also been utilized to separate carpet components. One or more segregated components are then recycled into products that generally compete with products produced from virgin polymers. There also exists a process to separate carpet waste using a cold, dry abrasive step as is taught in U.S. Pat. No. 5,704,104 to Bacon at al. Dry ice pellets are shot into an abrasive zone as a segment of discarded carpet on a conveyor system is stripped apart and disassembled. The dry ice pellets freeze the binder material (usually latex), lowering it to a temperature that makes the binder brittle and easy to break apart. The dry ice pellets sublimate directly into gas without any liquid resides.

Plastic resin compounds from waste generally contain two it immiscible plastics, nylon and polypropylene. The immiscibility of these two components leads to poor mechanical properties. Carpet may also be recycled using blending to produce commercial recycled carpet compounds.

U.S. Pat. No. 5,294,384 to David D. J. et al. describes a process to recycle all the components of post-consumer nylon 6,6 carpet, without separation, into a filled thermoplastic product suitable for injection molding. They used a twin screw extruder to accomplish high intensity mixing of the thermoplastic from carpet samples. The recycled material contained 35-67 wt % nylon, 8-21 wt % polypropylene, 5-29 wt % SBR and 10-40 wt % inorganic filler. In one study, no compatibilizer as used. The carpet samples were fed directiy into a twin screw extruder operating at about 250-260° C. and at a shear rate of 200 to 400 s-1. The tensile and Izod strengths of the extruded carpet were compared with those of the control sample, virgin polystyrene. The properties of the directly extruded thermoplastic were comparable to those of the virgin polystyrene. However, the properties of the extruded carpet were lower than virgin nylon 6,6.

U.S. Pat. No. 5,719,198 (Young, of al) describes a recycling method of preparing a polymeric blend formed from carpet scrap through the use of selected compatiblizing agents—PolyBond, Kraton or poly (ethylene-co-vinyl acetate) (EVA). The carpet scrap was from automotive carpet and the composition of the waste was significantly different from that of the residential carpet waste. The automotive carpet scrap contained 14 wt % nylon 6,6, 4 wt % PP, 11 wt % EVA, and 71 wt % BaSO4 filled EVA. The addition of the compatiblizing agents significantly improved the mechanical properties. For example, PolyBond 1001, even at 2 wt %, increased the tensile strength from 4.7 to 9.1 MPa, elongation at break from 7.6 to 17.5% and Izod impact strength (un-notched 254 to 471 J/m.

U.S. Pat. No. 5,855,981 (Zegler et al) describes a process to make the secondary backing for new carpet from the shredded carpet waste. The carpet waste could contain nylon 6, nylon 6,6, polyvinyl chloride, vinyl copolymer, polypropylene and polyethylene. The content of nylon was about 15 to 60 wt %. The chopped carpet waste was extruded at a temperature of 201° C., then calendaled and bonded to a primary backing of the new carpet through an adhesive coating.

Waste to energy conversion content of the waste materials may be recovered, at least in part, by burning the waste materials in air (incineration). Together, about 100 municipal solid waste (MSW) combustion facilities incinerated about 17% (35 million tons) of the municipal solid waste in the United States in 1996. Most of these facilitates have a waste to energy conversion process. Waste containing used paperwood products, contaminated packaging, and discarded tires has been combusted. The volume of these MSW is reduced by about 75% after incineration. The post-combustion ash still needs to be treated separately and then landfilled. Public concerns exist for the incineration of polymer waste. However, with advanced technologies and proper management, waste-to-energy conversion can be a viable alternative to landfilling. It is estimated that, if all the MSW that is currently generated in the United States were incinerated, the resultant carbon dioxide would be only 2% of that produced from the combustion of all other fossil fuels [90]. The current challenges for the incineration of polymer waste include further improving the incineration efficiency and reducing the harmful end products in the form of ash and noxious gases. The high combustion energy of polymer waste leads to decreased incineration capacity the incinerator is heat limited ash and noxious gases. The high combustion energy of polymer waste leads to decreased incineration capacity if the incinerator is heat limited.

Carpet waste has a simple composition compared to some other plastic waste streams. The major component in current carpet design is nylon, which requires up to 155 MJ/kg to manufacture, but gives off 29 MJ/kg when burned. The criterion for energy efficiency for incineration is that if it takes more than twice as much energy to make a plastic than what is recovered by burning, it is better to recycle the plastic than to burn it. This criterion clearly favors recycling nylon carpet waste over incineration.

Other known processes exist for recycling nylon fibers from carpet waste, based upon the separation and selective recovery of different polymeric nylon fiber fractions from the carpet waste. For example, in U.S. Pat. No. 5,898,063, Nylon 6 and Nylon 6,6, present in the carpet material, are separated into different phases before individual recovery. The carpet material is ground, mixed with a solvent and heated to an elevated temperature, equal to, at least, the dissolution temperature of one of the nylon fractions. Accordingly, by carrying out the process using selective heating of the solvent to at least the dissolution temperature of one of the nylon fractions, the nylon fractions are separated into phases, with one nylon fraction recovered by precipitation and at least one other nylon fraction separately removable as a solid. An alternative process is taught in U.S. Pat. No. 6,140,463, which involves selective heating of the solvent to an elevated temperature sufficient to dissolve at least one nylon fraction with the separation steps repeated to obtain a pure nylon product.

### SUMMARY OF INVENTION

The process of the present invention is directed to the separation and removal of inert components from carpet waste material with the inert components composed of carbonates, preferably calcium carbonate and/or aluminum and magnesium salts and/or silicates of aluminum, magnesium and calcium. Accordingly, the present invention broadly comprises the steps of placing carpet waste material into an acid solvent for solubilizing at least one or more of the inert components of the carpet material through chemical reaction with the acid solvent at low pH and at a temperature corresponding to room temperature or a low ambient reaction temperature below the dissolution temperature of nylon, polypropylene and polyester, such that, in addition to a liquid effluent containing the solubilized inert component(s), the residue from the reaction is a stream of fiberous textiles in solid phase.

At present calcium carbonate (“CaCO₃”) is the preferred inert component in the manufacture of carpets. The acid solvent is preferably either HCL or H₂SO₄. It is preferred that the acid solvent be mixed with water to form a low pH, preferably in a pH range of from 0.8 to 4 and more preferably in a pH range of between 0.8 and 2.0 and optimally at a pH of 1.5, to economically drive the reaction to cause the inert component to form a compound soluble in water such as calcium chloride, calcium sulfide or an aluminum or magnesium salt.

The inert component upon conversion to a solubilized salt permits recovery of the salt from the liquid effluent by conventional methods inclusive of: drying, extraction, centrifuging, distilling and freezing.

In the subject invention the inert component of the carpet waste material is converted into a soluble compound by reaction with an acid solvent in a reaction which occurs at room temperature or at a low ambient reaction temperature below the dissolution temperature of all of the textile fibers in the carpet waste such that the textile fibers remain in solid phase easily separated as a solid stream from the liquid effluent stream which contains a solubilized salt component. The residue of textile fibers upon separation from the liquid effluent may be used directly for forming a new or different carpet product or may be further recycled to separate the other solids in the residue from the textile fibers. Likewise, the inert component of the carpet waste is converted by reaction with the acid solvent into a soluble component which is commercially saleable. Accordingly, the process of the subject invention provides substantial advantages over conventional recycling processes in which the inert components are not easily separated from the textile fibrous material and by themselves have little or no commercial value.

### DETAILED DESCRIPTION OF THE INVENTION

Recycling, in general, currently involves methods for processing, conditioning and/or re-conditioning carpet waste for reuse or for conversion through mechanical, chemical, thermal or other means of the carpet waste into new or different products which may have more or less demanding generic applications which add value to the new or different products based on the recycled process.

Carpets are produced or manufactured using a backing material often containing polypropylene, polyethylene, acrylic resins, a straw burlap material commercially known as “Jute”, and or a mixture of these with possibly other materials in various amounts. It is also common to employ some kind of gluing, adhesion or binding agent in order to attach and securely bind the fibers of the carpet material to the backing. This glue, adhesion or binding agent is often premixed prior to application in the carpet producing process with a heavy inert material which provides durability and enables the carpet to be laid flat on the floor and prevents curl up of the carpet or dimensional shift of the carpet once installed. This inert material, which is currently composed primarily of calcium carbonate, can exist in percent of total weight of the carpet of from 10% to 75% by weight of the total carpet composition. Calcium carbonate or alternatives such as aluminum and magnesium salts and or silicate salts are not soluble in aqueous solvents, water or other oil type solvents. Calcium Carbonate may be obtained from: (1) egg shells, with many from pharmaceutical manufacturers that make the flu vaccines and the food processors that make fat free egg liquid products such as “Egg Beaters” or “Egg whites” in carton containers and/or (2) as by-products of chemical manufacturing facilities from neutralizing of various reaction products for safety handling. Although CaCO₃ is typically used as the inert material in carpet materials, it is known to cause the problem of “hard water” and is known in agriculture as “lime” for neutralizing soil.

The process of the subject invention can be advantageously and satisfactorily practiced to remove inert components from any conventional carpet composition which, upon disposal, may constitute the carpet waste feedstock or starting material. The inert components in carpet waste materials have contaminating properties and possess a hardness which can be abrasive on process equipment and in machinery used in a conventional recycling process such as, but not limited to, machinery for performing any of the following operations: collection, sorting, size reducing, conveying, drying and all other operations of a conventional recycling process. It should be understood that the carpet waste feedstock or starting material of the present invention may include polyesters, polyamides, poly-ethylene terephthalate nylons, acrylics and natural materials.

The inert component of almost all carpet compositions presently includes calcium carbonate but may be substituted by other inert sand like compounds having a similar chemical structure to that of CaCO₃. These inert compounds are similar to hard crystal solids and are, in general, non-dissolvable in water, aqueous solvents or other types of aqueous or oil solvents.

In accordance with one embodiment of the subject invention the starting carpet waste material is initially ground up, shredded, size reduced, modified in dimension or used in its whole form upon collection or in a modified dimensional state. The starting carpet waste material is then placed into an acid solvent, preferably hydrochloric acid (“HCL”) or sulfuric acid (“H₂SO₄”), for solubilizing the inert components of the carpet waste material, into a liquid phase with water in a reaction with the acid. The reaction converts the inert component of the carpet waste into a compound soluble in water and simultaneously provides a residue composed of a stream of fiberous textiles in solid phase. The liquid effluent consists of water and the dissolved solubilized compound(s) which may be dried to from a high purity salt.

The acid solvent reacts with the inert components of the starting carpet waste material releasing a benign nonhazardous salt, such as, for example, calcium chloride or calcium sulfide, which is water soluble. By diluting the acid, preferably in water, the acid and water mixture reacts with the inert component to safely yield a water dissolved soluble compound, such as a dissolved salt (e.g., CaCl₂), and by controlling the reaction temperature two products in two unique phases are formed one being a dissolved salt in a liquid phase and the other a solid stream of polymeric textile fibers. The inert component should be solubilized in the acid solvent at room temperature or at a low ambient reaction temperature since the reaction is exothermic and generates heat, such that the reaction temperature will not cause the nylon and/or polypropylene fibers in the carpet waste material to dissolve.

For the operation of the subject invention to be economical it is also essential that the acid solvent reaction take place at low pH, preferably in a pH range of from 0.8 to 4 and more preferably in a pH range of between 0.8 and 2.0 and optimally at a pH of 1.5 which will economically drive the reaction to convert the inert component into a compound soluble in water such as calcium chloride, calcium sulfide or an aluminum or magnesium salt.

When the acid solvent is hydrochloric acid (“HCL”) the chemical reaction with an inert component of CaCO₃ is as follows: CaCO₃+2HCl→CaCl₂+H₂O+CO₂ whereas when the acid solvent is sulfuric acid (“H₂SO₄”) the chemical reaction with an inert component of CaCO₃ is as follows: CaCO₃+H₂SO₄→CaSO₄+H₂O+CO₂.

The following Examples are typical process examples in accordance with the subject invention for separating the inert component which is typically calcium carbonate from carpet waste materials using either hydrochloric acid (“HCL”) or sulfuric acid (“H₂SO₄”) with the understanding that the invention is not limited to these acid solvents or to an inert component of CaCO₃.

### EXAMPLES

### Example—1

In this example, the carpet waste composition is a Nylon 6 carpet which may be recycled from either postconsumer home and/or commercial carpets. For this example a a postconsumer nylon carpet waste was selected, originally manufactured by Shaw Industries, having the following composition: 51% Nylon-6, 36% CaCO₃, 8% Polypropylene and 5% Styrene-butadiene-rubber. The carpet is cut into section approximately 12 inches square or one foot by foot. The carpet sections are place into a tank containing a solution composed of water and hydrochloric acid mixed to yield a ph equal to 1.5. The carpet is placed into the water-hydrochloric solution tank and agitated.

A chemical reaction takes place as follows:

CaCo₃+2HCl→CaCl₂+H₂O+CO₂

Upon completion of the reaction the finals products are found in three phases. The solid phase includes: Nylon 6, Polypropylene, and Styrene-butadiene-rubber. The liquid phase is calcium chloride dissolved in water. The gaseous phase CO₂ is minimal and properly exhausted. The following is an example of the method used in practicing this recovery and recycling process:
1.) Collect and sort the carpet into its fibrous components separating out the carpets that contains nylon 6 fiber,
2.) Test the initial Carpet in a lab furnace for its ash content at 550 C, the percent amount of inert that are not hydrocarbon therefore they do not burn at the 550 C temperature. This initial test yields a 36% ash content of the initial carpet,
3.) Using a 500 gallon agitated open mixing tank bend the correct amount of water and hydrochloric acid to yield a solution with a ph=1.5,
4.) If the carpets are too large for the mixing tank, cut the carpet to fit it to the tank
5.) Place the carpet into the vessel containing the water and hydrochloric acid mixture,
6.) As the reaction takes place introduce additional hydrochloric acid to the mixing tank in order to maintain the reaction by checking the ph of the total mixture (Carpet, water, and hydrochloric acid),
7.) Once the ph is stable and no more CO₂ gas bubbles are noticed the reaction is complete,
8.) Take the contents of the mixing tank and decant it saving both the liquid component and the solids component,
9.) Testing the solid component or stream in solid phase for ash content yields 0.82% ash and 99.18% volatile organic polymer component yielding a composition 80.20% Nylon-6, 12.2% polypropylene and 7.6% styrene-butadiene-rubber,
10.) Testing the liquid component yields a solution of dissolved calcium chloride in water,
11.) The calcium chloride water component stream was then dried yielding a high purity solid CaCl₂ powder and a separate high purity liquid water stream, and
12.) Recovering through recycling a stream of the high purity polymer component or a stream of the solid phase components, a stream of high purity calcium chloride and a water stream.

### Example−2

In this example the carpet waste composition is a Nylon 6,6 carpet, originally manufactured by Dupont Stainmaster, and has the following composition: 55% Nylon-66, 36% CaCO₃, 5% polypropylene and 4% styrene-butadiene-rubber. The carpet is cut into section approximately 12 inches square or one foot by foot. The carpet sections are place into a tank containing a solution as follows. The solution is composed of water and hydrochloric acid mixed to yield a ph equal to 1.5. The carpet is placed into the water-hydrochloric solution tank and agitated.

A thermal reaction takes place as follows:

CaCo₃+2HCl→CaCl₂+H₂O+CO₂

Upon completion of the reaction the finals products are found in three phases. The solid phase includes: nylon 6,6, polypropylene, and styrene-butadiene-rubber. The liquid phase consists of calcium chloride dissolved in water. The gaseous phase of CO₂ is minimal and properly exhausted. The remaining solid phase comprises the usable textile fiber polymers. The following is an example of the method used in practicing this recovery and recycling process
1.) Collect and sort the carpet into its fibrous components separating out the carpets that contains nylon 6 fiber,
2.) Test the initial Carpet in a lab furnace for its ash content at 550 C, the percent amount of inert that are not hydrocarbon therefore they do not burn at the 550 C temperature. This initial test yields a 36% ash content of the initial carpet,
3.) Using a 500 gallon agitated open mixing tank blend the correct amount of water and hydrochloric acid to yield a solution with a ph=1.5,
4.) If the carpets are too large for the mixing tank, cut the pet to fit it to the tank,
5.) Place the carpet into vessel containing the water and hydrochloric acid mixture,
6.) As the reaction takes place introduce additional hydrochloric acid to the mixing tank in order to maintain the reaction by checking the ph of the total mixture (Carpet, water, and hydrochloric acid),
7.) Once the ph is stable and no more CO₂ gas bubbles are noticed the reaction is complete,
8.) Take the contents of the mixing tank and decant it saving both tie liquid component and the solids component,
9.) Testing the solid stream for ash content yields 0.91% ash and 99.09% volatile organic polymer component yielding a composition 85.0% nylon-6,6, 9.0% polypropylene and 6.0% styrene-butadiene-rubber,
10.) Testing the liquid component fields a solution of dissolved calcium chloride in water,
11.) The calcium chloride water component stream was then dried yielding a high purity and pure water stream, and
12.) Recovering through recycling of a high purity polymer component stream, with a high purity calcium chloride stream and a water stream.

### EXAMPLE—3

In this example the carpet waste composition is a polyester carpet originally manufactured by Mohawk and has the following composition: 47% polyester, 37% CaCO3, 10% polypropylene and 6% styrene-butadiene-rubber. The carpet is cut into section approximately 12 inches square or one foot by foot. The carpet sections are place into a tank containing a solution as follows. The solution is composed of water and hydrochloric acid mixed to yield a ph equal to 1.5. The carpet is placed into the water-hydrochloric solution tank and agitated.

A chemical reaction takes place as follows:

CaCo₃+2HCl→CaCl₂+H₂O+CO₂

Upon completion of the reaction the finals products are found in three phases. The solid phase includes: Polyester, Polypropylene and Styrene-butadiene-rubber. The liquid phase consists of calcium chloride dissolved in water. The gaseous phase CO₂ is minimal and properly exhausted. The solid phase consists of only the usable polymers. The following is an example of the method used in practicing this recovery and recycling process
1.) Collect and sort the carpet into its fibrous components separating out the carpets that contains nylon 6 fiber
2.) Test the initial Carpet in a lab furnace for its ash content at 550 C, the percent amount of inert that are not hydrocarbon therefore they do not burn at the 550 C temperature. This initial test yields a 39% ash content of the initial carpet.
3.) Using a 500 gallon agitated open mixing tank blend the correct amount of water and hydrochloric acid to yield a solution with a ph=1.5
4.) If the carpets are too large for the mixing tank, cut the carpet to fit it to the tank.
5.) Place the carpet into the vessel containing the water and hydrochloric acid mixture.
6.) As the reaction takes place introduce additional hydrochloric acid to the mixing tank in order to maintain the reaction by checking the ph of the total mixture (Carpet, water, and hydrochloric acid)
7.) Once the ph is stable and no more CO₂ gas bubbles are noticed the reaction is complete
8.) Take the contents of the mixing tank and decant it saving both the liquid component and the solids component
9.) Testing the solid stream for ash content yields 1.2% ash and 98.8% volatile organic polymer component yielding a composition 74.78% Polyester, 15.68% Polypropylene and 9.54% Styrene-butadiene-rubber.
10.) Testing the liquid component yields a solution of dissolved Calcium Chloride in water.
11.) The calcium chloride water component stream was then dried yielding a high purity CaCl₂ powder and pure water stream.
12.) Recovering through recycling a stream of a high purity polymer component or a stream of the solid phase components, a stream of high purity calcium chloride and a water stream.

### Example—4

In this example the carpet waste composition is obtained from a solid waste stream of industrial carpet by-product, which is post-consumer processed carpet, originally manufactured by a major supplier, and has the following composition: 60% CaCO₃, 22% poiypropylene, 24% styrene-butadiene-rubber and 4% nylon. The waste stream solids are place into a tank containing a solution composed of water and hydrochloric acid mixed to yield a ph equal to 1.5. The carpet is placed into the water-hydrochloric solution tank and agitated.

A chemical reaction takes place as follows:

CaCO₃+2HCl→CaCl₂+H₇O+CO₂

Upon completion of the reaction the finals products are found in three phases. The solid phase consists of nylon, polypropylene and styrene-butadiene-rubber. The liquid phase consists of calcium chloride dissolved in water. The gaseous phase CO₂ is minimal and properly exhausted. The solid phase consists of only the usable polymers. The following is an example of the method used in practicing this recovery and recycling process
1.) Collect and sort the carpet into its fibrous components separating out the carpets that contains nylon 6 fiber,
2.) Test the initial Carpet in a lab furnace for its ash content at 550 C, the percent amount of inert that are not hydrocarbon therefore they do not burn at the 550 C temperature. This initial test yields a 59% ash content of the initial carpet,
3.) Using a 500 gallon agitated open mixing tank blend the correct amount of water and hydrochloric acid to yield a solution with a ph=1.5,
4.) Place the solids into the vessel containing the water and hydrochloric acid mixture,
5.) As the reaction takes place introduce additional hydrochloric acid to the mixing tank in order to maintain the reaction by checking the ph of the total mixture (solids, water, and hydrochloric acid),
6.) Once the ph is stable and no more CO₂ gas bubbles are noticed the reaction is complete,
7.) Take the contents of the mixing tank and decant it saving both the liquid component and the solids component,
8.) Testing the solid stream for ash content yields 8% ash and 92% volatile organic polymer component yielding a composition,
9.) Testing the liquid component yields a solution of dissolved calcium chloride in water,
10.) The calcium chloride water component stream was then dried yielding a high purity CaCl₂ powder and pure water stream, and
13.) Recovering through recycling a stream of the high purity polymer component or a stream of the solid phase components, a stream of high purity calcium chloride and a water stream.

### Example—5

In this example the carpet waste composition is obtained from a waste by-product stream of existing carpet recycling facilities with the waste stream composed of carcasses from a conventional shearing processes to form a solid waste stream of post-consumer mechanically sheared processed carpet originally manufactured by a major manufacturer with the solid waste stream having the following composition: 59% CaCO₃, 13% polypropylene, 11% styrene-butadiene-rubber and 17% nylon. Carcasses for the manufacture of carpets always contain one or more fibers of polypropylene and/or nylon with or without natural fibers. The carcasses are cut into section approximately 12 inches square or one foot by foot. The carcass sections are place into a tank containing a solution composed of water and hydrochloric acid mixed to yield a ph equal to 1.5. The carpet is placed into the water-hydrochloric solution tank and agitated.

A chemical reaction takes place as follows:

CaCO₃+2HCl→CaCl₂+H₂O+CO₂

Upon completion of the reaction the finals products are found in three phases. The solid phase consist of: nylon, polypropylene, styrene-butadiene-rubber. The liquid phase consists of calcium chloride dissolved in water. The gaseous phase CO₂ is minimal and properly exhausted. The following is an example of the method used in practicing this recovery and recycling process
1.) Collect and sort the carpet into its fibrous components separating out the carpets that contains nylon 6 fiber,
2.) Test the initial carcasses in a lab furnace for its ash content at 550 C, the percent amount of inert that are not hydrocarbon therefore they do not burn at the 550 C temperature. This initial test yields a 59% ash content of the initial carpet.
3.) Using a 500 gallon agitated open mixing tank blend the correct amount of water and hydrochloric acid to yield a solution with a ph=1.5,
4.) Race the carcasses into the vessel containing the water and hydrochloric acid mixture,
5.) As the reaction takes place introduce additional hydrochloric acid to the mixing tank in order to maintain the reaction by checking the ph of the total mixture (solids, water, and hydrochloric acid),
6.) Once the ph is stable and no more CO₂ gas bubbles are noticed the reaction is complete,
7.) Take the contents of the mixing tank and decant it saving both the liquid component and the solids component,
8.) Testing the solid stream for ash content yields 0.8% ash and 99.2% volatile organic polymer component yielding a composition,
9.) Testing the liquid component yields a solution of dissolved calcium chloride in water,
10.) The calcium chloride water component stream was then dried yielding a high purity CaCl₂ powder and pure water stream, and
11.) Recovering through recycling a high purity polymer component stream or a stream of the solid phase components, a stream of high purity calcium chloride and a water stream.

### Example—6

### Sulfuric Acid—Use of an Alternate Reactant to Produce CaSO₄

In this example the carpet waste composition is obtained as feedstock from a solid waste stream of post-consumer processed carpet originally manufactured by a major supplier having the following composition: 60% CaCO₃, 22% polypropylene, 24% styrene-butadiene-rubber and 4% nylon. The waste stream is place into a tank containing a solution composed of water and sulfuric acid mixed with water to yield a ph equal to 1.5. The carpet is placed into the water-sulfuric acid solution tank and a agitated.

A chemical reaction takes place as follows:

CaCO₃+H₂SO₄→CaSO₄+H₂O+CO₂

Upon completion of the reaction the finals products are found in three phases. The solid phase includes: nylon, polypropylene and styrene-butadiene-rubber. The liquid phase consist of calcium sulfate dissolved or dispersed in water. The gaseous phase of CO₂ is minimal and properly exhausted. The following is an example of the method used in practicing this recovery and recycling process
1.) Collect and sort the carpet into its fibrous components separating out the carpets that contains nylon 6 fiber,
2.) Test the initial carpet in a lab furnace for its ash content at 550 C, the percent amount of inert that are not hydrocarbon therefore they do not burn at the 550 C temperature. This initial test yields a 59% ash content of the initial carpet,
3.) Using 500 gallon agitated open mixing tank blend the correct amount of water and sulfuric acid to yield a solution with a ph=1.50,
4.) Place the solids into the vessel containing the water and hydrochloric acid mixture.
5.) As the reaction takes place introduce additional sulfuric acid to the mixing tank in order to maintain the reaction by checking the ph of the total mixture (solids, water, and sulfuric acid),
6.) Once the ph is stable and no more CO₂ gas bubbles are noticed the reaction is complete,
7.) Take the contents of the mixing tank and decant it saving both the liquid component and the solids component,
8.) Testing the solid stream for ash content yields 5% ash and 95% volatile organic polymer component yielding a composition,
9.) Testing the liquid component yields a solution of dissolved or dispersed calcium sulfate in water,
10.) The calcium sulfate water component stream was then dried yielding a high purity CaSO₄ powder and pure water stream, and
11.)Recovering through recycling a high purity polymer component stream or a stream of the solid phase components, a stream of high purity calcium sulfate and a water stream, it should be noted that the calcium sulfate product is usable as a construction material under the generic name Gypsum.

### Example—7

Since the reactions detailed in the above examples 1-6 use an acid as the reactant the kinetics of the system produces a thermodynamic exothermic reaction releasing heat.

The following is an example for using the method of the present invention with HCL as the acid solvent for energy recovery of heat of reactants for final salt precipitation:
1.) Collect and sort the carpet waste into its fibrous components separating out the carpets that contains nylon 6 fiber,
2.) Test the initial carpet in a lab furnace for its ash content at 550 C, the percent amount of inert that are not hydrocarbon therefore they do not burn at the 550 C temperature. This initial test yields a 59% ash content of the initial carpet,
3.) Using a 500 gallon agitated open mixing tank blend the correct amount of water and hydrochloric acid to yield a solution with a ph=1.50, taking the temperature of the mixture solution as 28 degrees Celsius,
4.) Place the solids pre-calculating an amount of 500 pounds of CaCO₃ in the mix into the vessel containing the water and hydrochloric acid mixture,
5.) As the reaction takes place introduce additional hydrochloric acid to the mixing tank in order to maintain the reaction by checking the ph of the total mixture (Solids, water, and hydrochloric acid),
6.) Once the ph is stable and no more CO₂ gas bubbles are noticed the reaction is complete. Taking the temperature of the final system as 44 degrees Celsius,
7.) Measuring the difference in temperature from initial to final results in an increase in temperature of 16 Degrees Celsius increase due to the exothermic nature of the chemical reaction kinetics,
8.) Decanting the water calcium chloride solution from the solids and placing the solution under vacuum evaporation at a pressure of 1 psig to cause increased concentration of the salt,
9.) The water evaporates at solution temperature of 39 Degrees Celsius. Note that the removal of water by evaporation increases the concentration of the dissolved calcium chloride in the final solution,
10.) Once the concentration of the calcium chloride reaches the critical super-saturated yield the calcium chloride will solidify in the solution, and
11.) This solidification at the super saturated yield concentration of water and calcium chloride produces a precipitated solid salt of highly pure calcium chloride utilizing the energy from the exothermic nature of the kinetics of the base reaction.

I claim:

1. A method for the separation and removal of inert components from carpet waste material(s) which include polymeric textile fibers comprising the steps of (a) placing the carpet waste material into an acid solvent, (b) solubilizing at least one inert component in the carpet waste material by chemical reaction with an acid solvent at low pH and (c) reacting the carpet waste material in the acid solvent at a temperature corresponding to room temperature or a low ambient reaction temperature below the dissolution temperature of any of the polymeric textile fibers in the carpet waste such that two unique phases are simultaneously formed during the reaction with one phase being a liquid phase consisting of a solubilized salt compound formed from the reaction of the inert component and the acid and the other phase comprising a stream of polymeric textile fibers in solid phase.

2- A method as defined in claim 1 wherein the acid solvent is diluted in water to form a low pH acid solution in a pH range of from 0.8 to 4.

3. A method as defined in claim 2 wherein said pH range is between 0.8 and 2.0.

4. A method as defined in claim 2 wherein the pH of the acid solvent solution is 1.5.

5. A method as defined in claim 2 wherein the add solvent is selected from the group consisting of HCL and H₂SO₄.

6. A method as defined in claim 5 wherein the inert component of the carpet waste material comprises CaCO₃.

7. A method as defined in claim 6 wherein the acid solvent is HCL for forming the following chemical reaction:
CaCO₃+2HCl→CaCl₂+H₂O+CO₂

8. A method as defined in claim 5 Wherein the inert component of the carpet waste material comprises CaSO₄,

9. A method as defined in claim 8 wherein the acid solvent is H₂SO₄ for forming the following chemical reaction:
CaCO₃+H₂SO₄→CaSO₄+H₂O+CO₂

10. A method for the separation and removal of inert components from carpet waste material formed from carcasses in a conventional shearing process to form a solid waste stream of post-consumer mechanically sheared processed carpet with the carpet waste material containing at least one polymer fiber selected from the class consisting of polypropylene and nylon with or without the addition of natural fibers comprising the steps of (a) placing the carpet waste material into an acid solvent solubilizing at least one inert component from the carpet waste material by chemical reaction with the acid solvent at low pH and (c) reacting the carpet waste material in the acid solvent at a temperature corresponding to room temperature or a low ambient reaction temperature below the dissolution temperature of any polymer fiber in the carpet waste such that two unique phases are simultaneously formed during the reaction with one phase being a liquid phase consisting of a solubilized salt compound formed from the reaction of the inert component and the add and the other phase comprising a stream of the polymeric fiber(s) in solid phase.

11. A method as defined in claim 10 wherein the acid solvent is diluted in water to form a low pH acid solution in a pH range of from 0.8 to 4.

12. A method as defined in claim 11 wherein the acid solvent is selected from the group consisting of HCL and H₂SO₄.

13. A method for the separation and removal of inert component(s) from carpet waste material(s) which include at least one polymeric fiber selected from the class consisting of polypropylene, polyester and nylon with the inert component(s) being converted into a salt using an acid solvent for forming a thermodynamic exothermic reaction controlling the reaction kinetics to precipitate salt in solidified form comprising the steps of (a) placing the carpet waste material into the acid solvent, (b) solubilizing at least one inert component from the carpet waste material by chemical reaction with the acid solvent at low pH, (c) reacting the carpet waste material at a controlled temperature corresponding to room temperature or a low ambient reaction temperature below the dissolution temperature of the polymeric fiber(s) in the carpet waste such that two unique phases are simultaneously formed during the reaction with one phase bend a liquid phase consisting of a solubilized salt compound formed from the reaction of the inert component and the acid and the other phase comprising a stream of polymeric textile fiber(s) in solid phase, (d) placing the liquid effluent solution from the reaction under vacuum sufficient to increase the concentration of the salt to its critical super-saturated state and to allow for evaporation of water and (e) precipitating the salt as a solid utilizing the energy from the exothermic nature of the kinetics of the base reaction.

14. A method as defined in claim 13 wherein the acid solvent is HCL and the inert component of the carpet waste material comprises CaCO₃ with the solution placed under vacuum at a pressure of at least 1 psig.
